(19) United States
(12) Patent Application Publication
(10) Pub. No.: US 2005/0213674 A1
(43) Pub. Date: Sep. 29, 2005

(54) Radio communication method and radio communication apparatus using adaptive modulation system

(76) Inventor: Takehiko Kobayashi, Kodaira (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/086,240

(22) Filed: Mar. 23, 2005

(30) Foreign Application Priority Data
Mar. 29, 2004 (JP) 2004-094113

(51) Int. Cl. H04L 27/00

(52) U.S. Cl. 375/259

(57) ABSTRACT

A propagation path estimator in a terminal station detects an average RSSI value for a downlink channel, and notifies a base station of the detected average RSSI value. The base station in turn receives the average RSSI value for the downlink channel from the terminal station, and detects an average RSSI value for an uplink channel by its propagation path estimator. Then, an adaptive modulation controller in the base station compares the lower one of the received average RSSI value for the downlink channel and the detected average RSSI value for the uplink channel with a threshold to determine a modulation scheme. The base station notifies the determined modulation scheme to the terminal station such that the modulation scheme is set to a modulator while a corresponding demodulation scheme is set to a demodulator in the terminal station.

### INCORPORATION BY REFERENCE

The present application claims priority from Japanese application JP 2004-094113 filed on Mar. 29, 2004, the content of which is hereby incorporated by reference into this application.

### BACKGROUND OF THE INVENTION

The present invention relates to a radio communication method and a radio communication apparatus for use in a system which makes bidirectional communications using an adaptive modulation system between a plurality of the radio communication apparatuses.

On radio transmission paths, the quality of transmission is susceptible to variations over time due to such influences as fading, rain attenuation and the like. For example, the quality of transmission tends to degrade under a situation where there are much noise, interfering waves, and attenuation, and to ameliorate under a situation where there are less noise, interfering waves, and attenuation. Conventionally, an adaptive modulation system has been proposed in order to accommodate variations in the quality of transmission over time on transmission paths as described above.

For example, when a high quality of transmission is ensured, the transmission efficiency is given higher priority, so that data is transmitted using an M-array modulation scheme such as 16 QAM (Quadrature Amplitude Modulation) which maps four bits on a complex plane, 64 QAM (Quadrature Amplitude Modulation) which maps six bits on a complex plane, or the like. As a result, more information source encoded data can be transmitted in a shorter time period.

On the other hand, when the quality of transmission is degraded, the immunity to transmission errors is given higher priority, so that data is transmitted using a transmission system called QPSK (Phase Shift Keying) which maps two bits on a complex plane. This permits data to be transmitted with few errors even though the quality of transmission is degraded.

Means conventionally known for adaptively changing modulation schemes include the followings, by way of example:
(1) A receiving condition of a station is determined based-on a received signal strength indicator (RSSI) or an equalization error output of an equalizer to select an appropriate modulation scheme for use in a transmission from the station based on the determined receiving condition (see, for example, JP-A-10-93650).
(2) A destination station is instructed to detect the quality of a received radio signal transmitted from a source station to determine an appropriate modulation scheme which is notified from the destination station to the source station which variably sets a modulation scheme therefor (see, for example, JP-A-10-41876).

### SUMMARY OF THE INVENTION

JP-A-10-93650 is appropriate for a system which employs the same frequency on an uplink transmission path and a downlink transmission path such as a TDD (Time Division Duplex) system because the uplink transmission path and downlink transmission path can be regarded as having the same transmission path characteristics. However, in a system which employs different frequencies on an uplink transmission path and a downlink transmission path such as an FDD (Frequency Division Duplex) system, JP-A-10-93650 is not always capable of selecting an appropriate modulation scheme because the uplink transmission path differs in the transmission path characteristics from the downlink transmission path.

On the other hand, the method described in JP-A-10-41876 can set optimal modulation schemes for transmission path characteristics even in a system which employs different frequencies on an uplink transmission path and a downlink transmission path such as an FDD system. However, since each station determines a modulation scheme for its destination station independently of each other, different modulation schemes can be set for the uplink transmission path and downlink transmission path. In this event, the method of JP-A-10-41876 cannot maintain the symmetry between the uplink and downlink in a so-called symmetric transmission path in which the transmission speeds of the uplink transmission path and downlink transmission path can vary at a certain rate. In addition, the method of JP-A-10-41876 disadvantageously fails to maintain an expected transmission rate on a so-called asymmetric transmission path in which the transmission speeds of the uplink transmission path and downlink transmission path can vary at a differing rate.

The present invention has been made in view of the foregoing circumstance, and it is an object of the invention to provide a radio communication method and a radio communication apparatus using an adaptive modulation system, which is capable of using the same modulation scheme at all times on an uplink transmission path and a downlink transmission path irrespective of a bidirectional multiplex system.

To achieve the above object, according to one aspect of the present invention, a radio communication method and a radio communication apparatus are provided for use in a system for making a bidirectional communication between a first communication apparatus and a second communication apparatus using an adaptive modulation system. The second communication apparatus estimates a state on a first transmission path for transmitting information from the first communication apparatus to the second communication apparatus, and notifies the estimated state on the first transmission path to the first communication apparatus. Together with the estimation of the state on the first transmission path, the first communication apparatus estimates a state on a second transmission path for transmitting information from the second communication apparatus to the first communication apparatus. Then, the first communication apparatus determines a modulation scheme for use in the bidirectional communication based on the state on the first transmission path notified from the second communication apparatus and the state on the second transmission path estimated by the first communication apparatus, such that the bidirectional communication is made between the first communication apparatus and the second communication apparatus using the determined modulation scheme.

Thus, according to the present invention, the first communication apparatus determines a modulation scheme in consideration of the propagation path characteristics both on the first and second transmission paths. Therefore, an appropriate modulation scheme can be set in accordance with the states on the transmission paths in an FDD system as well, not to mention a TDD system. Moreover, the same modulation scheme can be used at all times on the first and second transmission paths. Consequently, the symmetry can be held without fail between the first and second transmission paths on a symmetric transmission path, while a stable asymmetric transmission can be maintained on an asymmetric transmission path by preventing a change in the ratio of asymmetric transmission depending on the modulation scheme. Further, the first communication apparatus globally determines the modulation scheme for the first and second transmission path. Therefore, for example, even a requirement for a change in a threshold, if any, can be advantageously met only by a change in the first communication apparatus.

The present invention is also characterized by a variety of configurations which can be taken by means for determining a modulation scheme and means for making the bidirectional communication using the determined modulation scheme as follows.

A first configuration is adapted when a first transmission path and a second transmission path has symmetry, and involves selecting a lower quality from the states on the first transmission path and second transmission path, and determining a modulation scheme in accordance with the state of the selected transmission path.

According to the foregoing configuration, a modulation scheme for use on each of the first and second transmission paths is determined based on the lower propagation path quality. In other words, the guarantee of the propagation path quality is given higher priority in determining a modulation scheme. Therefore, even if one of the first and second transmission paths is degraded in the propagation path quality in an FDD system, the system can make a stable radio communication with less errors while maintaining the immunity to transmission errors on the transmission path which is degraded in the propagation path quality.

A second configuration is adapted when a first transmission path and a second transmission path has asymmetry, and involves selecting a transmission path which has a wider transmission band or a higher transmission rate from the first and second transmission paths, and determines a modulation scheme in accordance with the state of the selected transmission path.

According to the foregoing configuration, a modulation scheme is determined in accordance with the propagation path quality of the transmission path having a wider transmission band of the first and second transmission paths. In other words, the guarantee of transmission efficiency is given higher priority in determining a modulation scheme. Therefore, for example, when a transmission path having a narrower band is lower in the propagation path quality than a transmission path having a wider band, it is possible to sufficiently ensure the transmission capacity for the transmission path having a wider band without being constrained by the lower propagation path quality of the transmission path having a narrower band.

A third configuration involves storing log information which includes at least one of the states on the first and second transmission paths estimated in the past and modulation schemes determined in the past, and determining a modulation scheme based on newly estimated states on the first and second transmission paths and the stored log information.

In the configuration described above, a modulation scheme is determined in consideration not only of recent propagation path qualities on the uplink and downlink transmission paths but also of past propagation path qualities. It is therefore possible to alleviate the influence of temporary fluctuations in the propagation path quality and stably determine a modulation scheme.

In a fourth configuration, a first communication apparatus has means for transmitting information for indicating a determined modulation scheme to a second communication apparatus, causing the second communication apparatus to receive the information and change its modulation scheme in accordance with the received information, and the first communication apparatus includes means for estimating a time period from a time at which the information is transmitted to a time at which the second communication apparatus has changed the modulation scheme, and change timing control means for delaying a timing at which the first communication apparatus changes its modulation scheme based on the estimated time period.

In the configuration as described above, the first and second communication apparatuses can change the modulation scheme at the same timing, thereby making it possible to accomplish a smooth bidirectional communication even if the modulation scheme is changed.

In a fifth configuration, a first and a second communication apparatus include QoS (Quality of Service) control means for transmitting first information when a transmission rate is equal to or higher than a first value and second information when the transmission rate falls down to less than the first value, and the first communication apparatus includes means for determining a manner in which a modulation scheme is changed, and change timing control means. Upon determination of a change from a first modulation scheme corresponding to a first transmission rate to a second modulation scheme corresponding to a second transmission rate lower than the first transmission rate, the change timing control means changes the modulation scheme after the lapse of a time period required by the QoS control means to control switching of transmission information.

In the configuration as described above, when a degradation in propagation path characteristics causes a change in the transmission rate and modulation scheme, the modulation scheme is changed in consideration of a time period required for the QoS control. This avoid a disadvantage of missing the QoS control for a change in the transmission rate and modulation scheme, thereby preventing a loss of information.

The essence of the present invention lies in the estimation of the respective states on the first and second transmission paths which make up a bidirectional transmission path, and selection of a modulation scheme commonly used for the respective transmission paths in consideration of the states on both the transmission paths.

Therefore, the present invention can provide a radio communication method and a radio communication apparatus using an adaptive modulation system which can employ the same modulation scheme at all times on an uplink transmission path and a downlink transmission path irrespective of a bidirectional multiplexing system.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram illustrating the configuration of a radio communication system according to a first embodiment of the present invention;

FIGS. 2A and 2B are diagrams showing formats for a downlink and an uplink transmission frame, respectively, for use in the system illustrated in FIG. 1;

FIG. 3 is a graph showing an error rate characteristic for use in describing the operation of the system illustrated in FIG. 1;

FIG. 4 is a diagram for describing a sequence of operations performed by the system illustrated in FIG. 1;

FIG. 5 is a flow chart illustrating a sequence of operations for determining a modulation scheme in the first embodiment;

FIG. 6 is a diagram illustrating a sequence of operations performed by a radio communication system according to a second embodiment of the present invention;

FIG. 7 is a flow chart illustrating a modification to the operations for determining a modulation scheme in the present invention; and

FIG. 8 is a schematic diagram illustrating an exemplary configuration of the present invention which is applied to an FWA radio communication system.

### DETAILED DESCRIPTION OF THE EMBODIMENTS

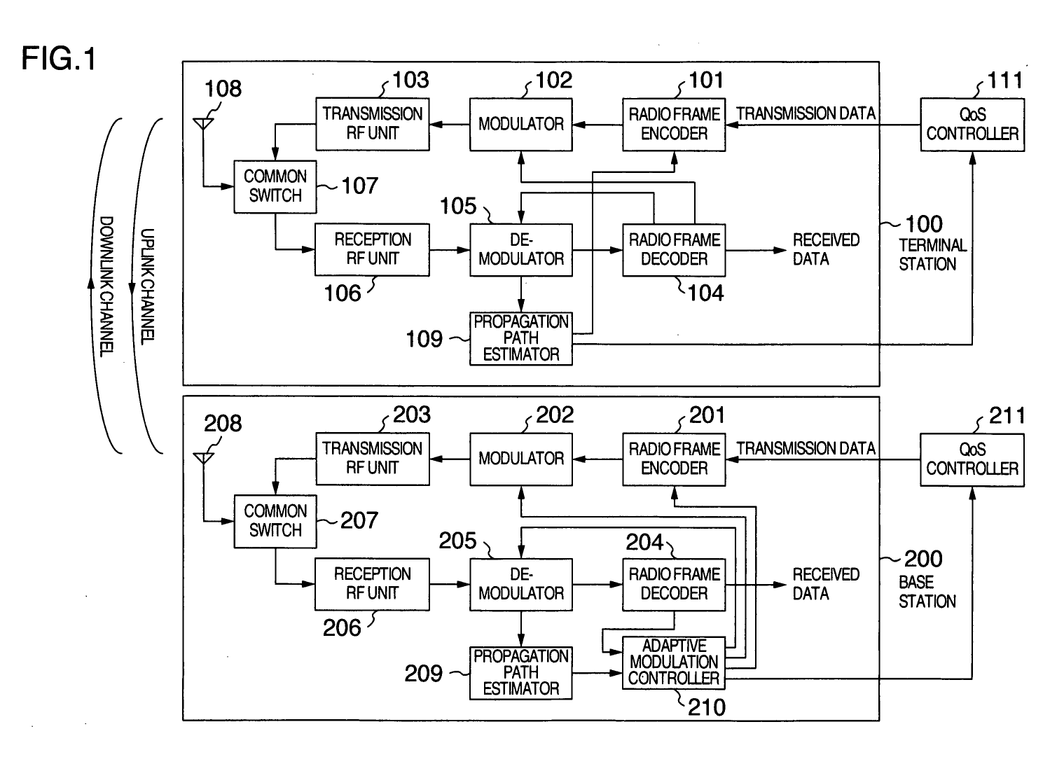

FIG. 1 is a block diagram illustrating the configuration of a radio communication system according to a first embodiment of the present invention. The illustrated system has a base station 200 and a plurality of terminal stations 100 which are connected through a bidirectional transmission path comprised of an uplink channel and a downlink channel. A bidirectional transmission system used herein may be an FDD (Frequency Division Duplex) system. Since the respective terminal stations 100 are identical in configuration, FIG. 1 shows only one terminal station and omits the remaining stations.

The terminal station 100 has a transmission section which comprises a radio frame encoder 101, a modulator 102, and a transmission RF unit 103, and a reception section which comprises a reception RF unit 106, a demodulator 105, and a radio frame decoder 104. These transmission section and reception section are connected to an antenna 108 through a common switch 107.

The radio frame encoder 101 corrects errors in transmission data supplied from an information input/output unit, not shown, encodes the error corrected transmission data, and inserts the encoded transmission data into a data field of an uplink transmission frame. The modulator 102, which has a function corresponding to an adaptive modulation system, converts the uplink transmission frame, into which the encoded transmission data has been inserted, to a modulated signal in accordance with a specified modulation scheme, and supplies the modulated signal to the transmission RF unit 103. The transmission RF unit 103 comprises a frequency converter and a transmission power amplifier. The transmission RF unit 103 converts the modulated signal supplied from the modulator 102 to a radio frequency for an uplink channel, and amplifies the modulated signal to a predetermined transmission power level, and supplies the amplified radio signal to the antenna 108 through the common switch 107 for transmission.

The reception RF unit 106 comprises a low-noise amplifier and a frequency converter. The reception RF unit 106 amplifies a radio signal received by the antenna 108 using the low-noise amplifier, and then converts the amplified signal to a received signal at an intermediate frequency or a baseband frequency using the frequency converter. The demodulator 105 demodulates the received signal, which has been frequency converted by the reception RF unit 106, in accordance with a demodulation scheme corresponding to the modulation scheme set to the modulator 102, and inputs a downlink transmission frame to the radio frame decoder 104. The radio frame decoder 104 performs decode processing including correcting possible errors in information data contained in the downlink transmission frame inputted thereto, and decompressing the information data. Then, the received data reproduced by such decode processing is supplied to an information input/output unit, not shown.

The terminal station 100 has functions according to the present invention which include a function of estimating a propagation path on the downlink channel, a function of notifying the base station 200 of the result of the estimation, and a function of setting a modulation scheme specified by the base station 200. The function of estimating a propagation path on the downlink channel is installed in a propagation path estimator 109. The propagation path estimator 109 fetches a received signal on the downlink channel from the demodulator 105 to detect its RSSI (Received Signal Strength Indicator). Then, the propagation path estimator 109 supplies the detected RSSI value to the radio frame encoder 101 as the result of estimating the propagation path.

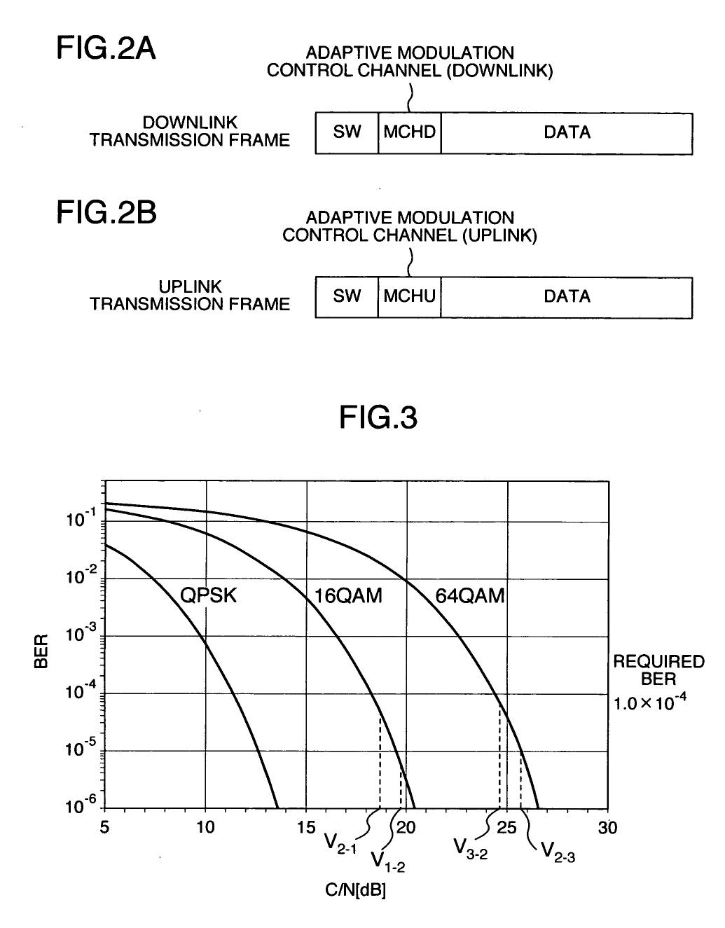

The function of notifying the base station 200 of the propagation path estimation result is installed in the radio frame encoder 101. The radio frame encoder 101 generates an uplink transmission frame composed of a synchronization word (SW), an uplink adaptive modulation control channel (MCHU), and an information data field (DATA), as shown in FIG. 2B. Then, the radio frame encoder 101 inserts the detected RSSI value supplied from the propagation path estimator 109 into the uplink adaptive modulation control channel (MCHU), and transmits the resulting uplink transmission frame to the base station 200.

The function of setting a modulation scheme specified by the base station 200 is installed in the radio frame demodulator 104. A downlink transmission frame transmitted from the base station 200 is composed of a synchronization word (SW), a downlink adaptive modulation control channel (MCHD), and an information data field (DATA), as shown in FIG. 2A. The radio frame decoder 104 extracts modulation indication data from the downlink adaptive modulation control channel (MCHD) of a received downlink transmission frame. Then, in accordance with the extracted modulation indication data, the radio frame decoder 104 specifies a modulation scheme to the modulator 102 and demodulator 105. A timing at which the modulation scheme is specified is set to be synchronized to a timing at which each of uplink and downlink transmission frame is transmitted or received.

The base station 200 is configured in the following manner. Specifically, the base station 200 is similar to the terminal station 100 in that it has a transmission section which comprises a radio frame encoder 201, a modulator 202, and a transmission RF unit 203, and a reception section which comprises a reception RF unit 206, a demodulator 205, and a radio frame decoder 204. Then, these transmission section and reception section are connected to an antenna 208 through a common switch 207.

The radio frame encoder 201 corrects errors in transmission data supplied from an information processing apparatus, not shown, encodes the error corrected transmission data, and inserts the encoded transmission data into a data field of a downlink transmission frame. The modulator 202, which has a function corresponding to an adaptive modulation system, converts the downlink transmission frame, into which the encoded transmission data has been inserted, to a modulated signal in accordance with a specified modulation scheme, and supplies the modulated signal to the transmission RF unit 203. The transmission RF unit 203 comprises a frequency converter and a transmission power amplifier. The transmission RF unit 203 converts the modulated signal supplied from the modulator 202 to a radio frequency for a downlink channel, and amplifies the modulated signal to a predetermined transmission power level, and supplies the amplified radio signal to the antenna 208 through the common switch 207 for transmission.

The reception RF unit 206 comprises a low-noise amplifier and a frequency converter. The reception RF unit 206 amplifies a radio signal received by the antenna 208 using the low-noise amplifier, and then converts the amplified signal to a received signal at an intermediate frequency or a baseband frequency using the frequency converter. The demodulator 205 demodulates the received signal, which has been frequency converted by the reception RF unit 206, in accordance with a demodulation scheme corresponding to the modulation scheme set to the modulator 202 to reproduce an uplink transmission frame, and inputs the uplink transmission frame to the radio frame decoder 204. The radio frame decoder 204 performs decode processing including correcting possible errors in information data contained in the uplink transmission frame inputted thereto, and decompressing the information data. Then, the received data reproduced by such decode processing is supplied to an information processing apparatus, not shown.

The base station 200 has functions according to the present invention which includes a function of estimating a propagation path on the uplink channel, a function of receiving a detected RSSI value for a downlink channel, notified from a terminal station 100, and a function of determining a modulation scheme. The function of estimating a propagation path on the uplink channel is provided in a propagation path estimator 209. The propagation path estimator 209 fetches a received signal on the uplink channel from the demodulator 205 to detect its RSSI (Received Signal Strength Indicator).

The function of receiving a detected RSSI value for a downlink channel is installed in the radio frame decoder 204. An uplink transmission frame transmitted from a terminal station 100 is composed of a synchronization word (SW), an uplink adaptive modulation control channel (MCHU), and an information data field (DATA), as previously shown in FIG. 2A. The radio frame decoder 204 extracts a detected RSSI value from the uplink adaptive modulation control channel (MCHU) of the received uplink transmission frame.

The function of determining a modulation scheme is installed in an adaptive modulation controller 210. As will be later described, the adaptive modulation controller 210 fetches a detected RSSI value for the uplink channel from the propagation path estimator 209, and fetches a detected RSSI value for the downlink channel from the radio frame decoder 204. Then, the adaptive modulation controller 210 compares the smaller one of the fetched detected RSSI values for the uplink and downlink channels with a previously set threshold to determine a modulation scheme. Then, the adaptive modulation controller 210 notifies the radio frame encoder 201 of the determined modulation scheme, and sets the determined modulation scheme in the modulator 202 and demodulator 205, respectively. A timing at which the modulation scheme is set is determined in consideration of a processing delay which is produced until the modulation scheme is set in the terminal station 100 after the modulation scheme has been notified to the terminal station 100.

The function of notifying the terminal station 100 of a determined modulation scheme is installed in the radio frame encoder 201. The radio frame encoder 201 generates a downlink transmission frame composed of a synchronization word (SW), a downlink adaptive modulation control channel (MCHD), and an information data field (DATA), as shown in FIG. 2A. Then, the radio frame encoder 201 inserts modulation scheme indication data notified from the adaptive modulation controller 21 into the downlink modulation control channel (MCHD) which is transmitted to the terminal station 100.

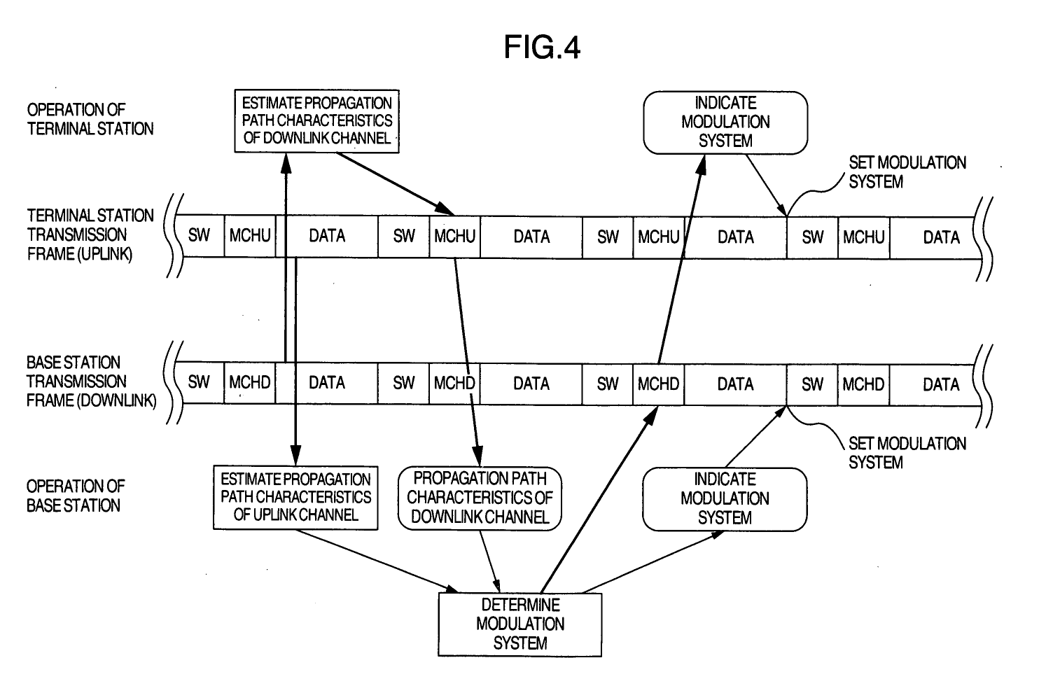

Next, description will be made on the operation of controlling an adaptive modulation system by the system configured as described above. FIG. 4 is a sequence diagram illustrating an operation procedure for controlling the adaptive modulation system.

As a communication of information data is started between the base station 200 and the terminal station 100, the propagation path estimator 109 estimates the quality of a propagation path on the downlink channel on a periodic basis in the terminal station 100. The propagation path quality is estimated by detecting an average value of RSSIs of received signals for a period in which the terminal station 100 receives the data fields of the downlink transmission frames from which the estimation is made. Upon detection of the average RSSI value for the downlink channel, the radio frame encoder 101 inserts the average RSSI value into the adaptive modulation control channel (MCHU) of the next uplink transmission frame, as shown in FIG. 4. Then, the uplink transmission frame is modulated by the modulator 102, converted into a radio signal by the transmission RF unit 103, and transmitted to the base station 200 from the antenna 107.

In the base station, in turn, the propagation path estimator 209 estimates the quality of a propagation path on the uplink channel on a periodic basis. The propagation path quality is also estimated by detecting an average value of RSSIs in received signals for a period in which the base station 200 receives the data fields of the uplink transmission frames from which the estimation is made, in a manner similar to the terminal station 100. In addition, in the base station 200, each time an uplink transmission frame is received from the terminal station 100, the average RSSI value for the downlink channel is extracted from the adaptive modulation control channel (MCHU) of the received uplink transmission frame.

Given the average RSSI values for the uplink and downlink channels, respectively, the adaptive modulation controller 210 performs processing for determining a modulation scheme. The determination of a modulation scheme is made by previously setting a threshold for the RSSI corresponding to a plurality of candidate modulation schemes, and comparing the lower one of the average RSSI value for the uplink channel and the average value for the downlink channel with the threshold.

For example, assuming that there are candidate modulation schemes QPSK, 16QAM, and 64QAM, these modulation schemes present theoretical values for the characteristic of the bit error rate (BER) to a carrier power to noise power ratio (C/N) as shown in FIG. 3. While FIG. 3 represents the C/N on the vertical axis, the C/N is equivalent to the RSSI in an appropriately configured communication apparatus. In FIG. 3, assuming that required BER is 1.0×10⁻⁴, thresholds are set at V₂₋₁, V₁₋₂, V₃₋₂, V₂₋₃ corresponding to 16 QAM and 64 QAM, respectively.

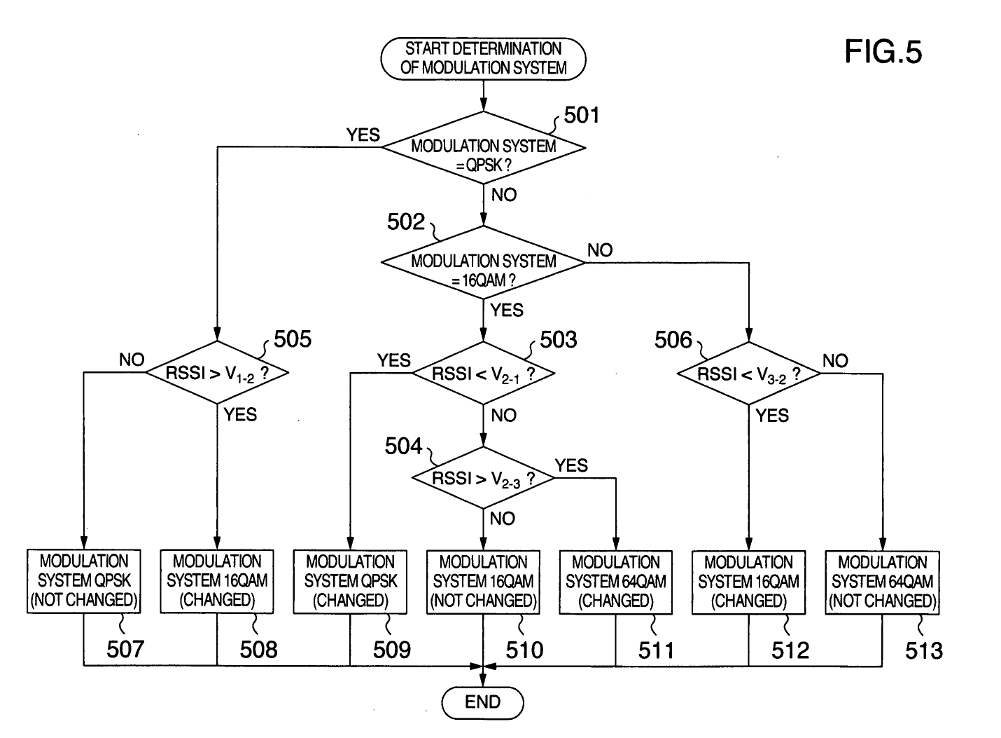

Then, under the foregoing condition, the adaptive modulation controller 210 determines a modulation scheme in the following manner in accordance with a flow chart illustrated in FIG. 5. Specifically, the adaptive modulation controller 210 first determines whether or not a currently set modulation scheme is QPSK (step 501). The flow proceeds to step 505 when QPSK is set, and to step 502 when a modulation scheme other than QPSK is set. At step 502, the adaptive modulation controller 201 determines whether or not the currently set modulation scheme is 16 QAM, and the flow proceeds to step 503 when 16 QAM is set, and to step 506 when a modulation scheme other than 16 QAM is set.

At step 505, the adaptive modulation controller 210 determines whether or not the lower one of the uplink channel average RSSI value and downlink channel average RSSI value exceeds the threshold V₁₋₂, and selects 16 QAM as an appropriate modulation scheme when the average RSSI value exceeds the threshold V₁₋₂ (step 508). On the other hand, the adaptive modulation controller 210 maintains the currently set modulation scheme, i.e., QPSK when the average RSSI value is equal to or lower than the threshold V₁₋₂ (step 507).

When the currently set modulation scheme is 16 QAM, the adaptive modulation controller 210 determines at step 503 whether or not the lower one of the uplink channel average RSSI value and downlink channel average RSSI value is lower than the threshold V₂₋₁, and determines at step 504 whether or not the average RSSI value exceeds the threshold V₂₋₃. When the lower one of the uplink channel average RSSI value and downlink channel average RSSI value exceeds the threshold V₂₋₃, the adaptive modulation controller 210 selects 64 QAM as an appropriate modulation scheme in this situation (step 511). On the other hand, when the lower one of the uplink channel RSSI value and downlink channel RSSI value exceeds the threshold V₂₋₁ and is equal to or lower than the threshold V₂₋₃, the adaptive modulation controller 210 maintains the currently set modulation scheme, i.e., 16 QAM (step 510). Further, when the lower one of the uplink channel average RSSI value and downlink channel average RSSI value is lower than the threshold V₂₋₁, the adaptive modulation controller 210 selects QPSK as an appropriate modulation scheme in this situation.

Similarly, when the currently set modulation scheme is 64 QAM, the adaptive modulation controller 210 determines at step 506 whether or not the lower one of the uplink channel detected RSSI value and the downlink channel detected RSSI value exceeds the threshold V₃₋₂. When the detected RSSI value is lower than threshold V₃₋₂, the adaptive modulation controller 210 selects 16 QAM as an appropriate modulation scheme in this situation (step 512). On the other hand, when the detected RSSI value exceeds the threshold V₃₋₂, the adaptive modulation controller 201 maintains the currently set modulation scheme, i.e., 64 QAM (step 513).

It should be noted that the V₂₋₁ is not set equal to V₁₋₂ and V₃₋₂ is not set equal to V₂₋₃ in order to prevent frequent switching of modulation schemes near the boundaries.

Once the modulation scheme is determined as described above, the adaptive modulation controller 210 creates change instruction data for changing the currently used modulation scheme to the determined modulation scheme, and notifies the change instruction data to the radio frame encoder 201. The radio frame encoder 201 inserts the change instruction data into the adaptive modulation control channel (MCHD) of a subsequent downlink transmission frame, and outputs the resulting downlink transmission frame to the modulator 202, as shown in FIG. 4. As a result, the change instruction data is modulated by the modulator 202, further converted to a radio signal by the transmission RF unit 203, and transmitted from the antenna 207 to a destination terminal station 100.

In the terminal station 100, in turn, upon receipt of the downlink transmission frame from the base station 200, the radio frame decoder 104 extracts the change instruction data from the adaptive modulation control channel (MCHD) of the received downlink transmission frame. Then, in accordance with the extracted change instruction data, the radio frame decoder 104 instructs the modulator 102 to set a modulation scheme at the time the next uplink transmission frame is started, and instructs the demodulator 105 to set a demodulation scheme corresponding to the modulation scheme set by the modulator 102 at the time the next downlink transmission frame is started. Thus, in accordance with the received change instruction data, an appropriate modulation scheme is set to the modulator 102, while a demodulation scheme corresponding to the modulation scheme is set to the demodulator 105. Consequently, uplink transmission frames subsequently transmitted from the terminal station 100 are modulated in accordance with the set modulation scheme for transmission.

In the base station 200, once the modulation scheme is determined, the adaptive modulation controller 210 instructs the modulator 202 to set the modulation scheme, and the demodulator 205 to set the demodulation scheme corresponding to the modulation scheme, thereby setting the determined modulation scheme to the modulator 202 and the demodulation scheme corresponding to the modulation scheme to the demodulator 205.

In this event, the timing at which the modulation scheme and demodulation scheme are set to the modulator 202 and demodulator 205 are set at a timing at which the next frame is started subsequent to the downlink transmission frame which has transmitted the change instruction data, as shown in FIG. 4. Thus, the modulation scheme and demodulation scheme are changed in the base station 200 at the same timing at which the modulation scheme and demodulation scheme are changed in the terminal station 100. In this way, information data can be subsequently communicated bidirectionally between the base station 200 and the terminal station 100 in synchronism with each other in accordance with the changed modulation scheme and demodulation scheme.

As described above, in the first embodiment, the propagation path estimator 109 of the terminal station 100 detects an average RSSI value for the downlink channel, and notifies the base station 200 of the detected average RSSI value through the adaptive modulation control channel (MCHU) of the uplink transmission frame. On the other hand, the base station 200 receives the average RSSI value for the downlink channel from the terminal station 100, and the propagation path estimator 209 detects an average RSSI value for the uplink channel. Then, the adaptive modulation controller 210 compares the received average RSSI value for the downlink channel with the detected average RSSI value for the uplink channel to select the lower value, and compares the selected average RSSI value with the thresholds V₂₋₁, V₁₋₂, V₃₋₂, V₂₋₃ to determine a modulation scheme. Then, modulation scheme change instruction data is notified to the terminal station 100 through the adaptive modulation control channel (MCHD) of the downlink transmission frame, whereby the determined modulation scheme is set to the modulator 102, while the demodulation scheme corresponding to the modulation scheme is set to the demodulator 105. Also, together with this, the base station 200 sets the determined modulation scheme and corresponding demodulation scheme to the modulator 202 and demodulator 203, respectively, in synchronism with the timing at which the like settings are made in the terminal station 100.

Thus, according to the first embodiment, a modulation scheme is determined in consideration of the propagation path characteristics of both the uplink and downlink channels. It is therefore possible to employ the same modulation scheme at all times on both the uplink channel and the downlink channel. Consequently, the symmetry between the uplink and downlink can be securely held in a symmetric transmission path, while a stable asymmetric transmission can be maintained in an asymmetric transmission path by preventing a change in the ratio of asymmetric transmission.

Also, upon determination of a modulation scheme, a modulation scheme is set in favor of the propagation path quality of a channel which presents degraded propagation path characteristics. In other words, a modulation scheme is determined with higher priority given to the guarantee of the propagation path quality. Consequently, even if the propagation path characteristics are degraded only on one of the uplink and downlink channels in an FDD system, the system can provide stable bidirectional radio information communications with less errors by maintaining the immunity to transmission errors on the channel which presents degraded propagation path characteristics.

Further, the base station 200 globally determines a modulation scheme for the uplink and downlink channels. Therefore, for example, even a requirement for a change in a threshold, if any, can be advantageously met only by a change in the base station 200.

Further, a timing at which the base station 200 sets a modulation scheme is delayed in a controlled manner so as to be synchronized to a timing at which the terminal station 100 sets the modulation scheme. This permits the base station 200 and terminal station 100 to change the modulation scheme at the same timing, thereby making it possible to accomplish smooth bidirectional communications even if the modulation scheme is changed.

In a second embodiment of the present invention, when the base station and terminal station are equipped with a so-called QoS (Quality of Service) control means for transmitting all data when an available transmission rate is equal to or higher than a predetermined rate and for preferentially transmitting more important data such as data required in real time, control data and the like when the transmission rate falls down to the predetermined rate or lower, the adaptive modulation control according to the present invention is combined with the QoS control to achieve a more effective QoS control.

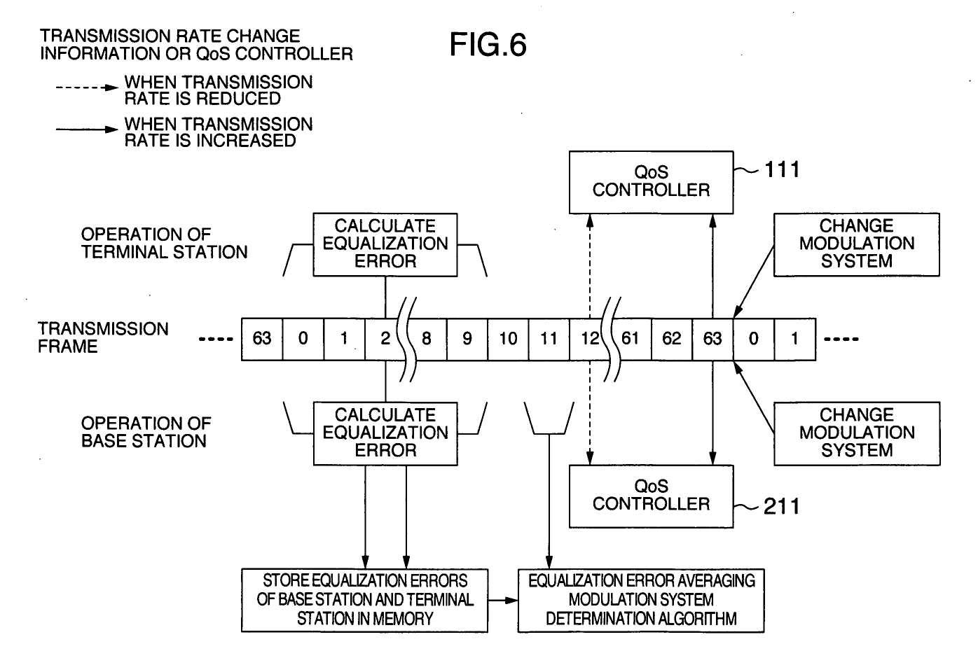

FIG. 6 is a sequence diagram of a system for describing the second embodiment of the present invention. Since the base station and terminal station are identical in basic configuration to those in the first embodiment, the second embodiment will be described additionally with reference to FIG. 1.

The base station 200 and terminal station 100 conduct the adaptive modulation and QoS control in the following manner at a cycle of 64 transmission frames. First, during a period of ten frames with frame numbers “0”-“9,” the propagation path characteristics are estimated for the uplink channel and down link channel, respectively. The estimation of the propagation path characteristics is made by calculating an equalization error of received data in each of the frames “0”-“9.” The terminal station 100 sequentially or collectively transmits the calculated equalization errors for 10 frames of the downlink channel to the base station 200 using the adaptive modulation control channel (MCHU) of the uplink transmission frame. On the other hand, the base station 200 receives the equalization error transmitted from the terminal station 100, and once stores the equalization error in a memory within the adaptive modulation controller 210. Similarly, the base station 200 stores equalization errors for ten frames on the uplink channel calculated in the propagation path estimator 209 in the memory within the adaptive modulation controller 210.

Next, the adaptive modulation controller 210 of the base station 200 reads equalization errors for ten frames on the downlink channel and equalization errors for ten frames on the uplink channel from the memory during a period in which a frame “11” is transmitted, and calculates average values of these equalization errors, respectively. Then, the adaptive modulation controller 210 compares the calculated average equalization error value for the downlink channel with the average equalization error value for the uplink channel to select the larger one of these average equalization error values. In other words, the adaptive modulation controller 210 selects one of the uplink channel and downlink channel which exhibits degraded propagation path characteristics. Subsequently, the adaptive modulation controller 210 compares the selected average equalization error value with a previously set threshold to determine an optimal modulation scheme in accordance with the average equalization error value. For determining this optimal modulation scheme, the algorithm described in the first embodiment can be used.

Next, the adaptive modulation controller 210 of the base station 200 controls the notification of the modulation scheme in accordance with changed contents of the determined modulation scheme. Specifically, first, when the modulation scheme is changed from a higher M-array modulation scheme, for example, 64 QAM and 16 QAM to a lower M-array modulation scheme such as QPSK, the adaptive modulation controller 210 notifies the terminal station 100 of modulation scheme change instruction data using the adaptive modulation control channel (MCHD) in a period of a frame “12” as shown in FIG. 6. In other words, the modulation scheme is notified using a downlink transmission frame which is transmitted immediately after the processing for determining the modulation scheme.

Upon arrival of the modulation scheme change instruction data, the terminal station 100 immediately provides a QoS controller 111 with transmission rate change information corresponding to this change instruction data. Then, at the time the frame “0” starts, the terminal station 100 sets switching to the modulation scheme for the modulator 102, and to the corresponding demodulation scheme for the demodulator 105. Therefore, the QoS controller 111 of the terminal 100 can prepare for the QoS control making use of a sufficiently long time period from the reception of the transmission rate change information in the frame “12” to the switching of the modulation scheme in the frame “0.” This can obviate a loss of information data due to a delay in supporting the QoS control.

The adaptive modulation controller 201 of the base station 200 also provides its local QoS controller 211 with the transmission rate change information in the period of a frame “12” in a manner similar to the change instruction operation for the terminal station 100. Then, the adaptive modulation controller 210 sets switching to the modulation scheme for the modulator 202 and to the demodulation scheme corresponding to the modulation scheme for the demodulator 205 at the start of the frame “0.” Therefore, the QoS controller 211 of the base station 200 can also prepare for the QoS control making use of a sufficiently long time period from the reception of the transmission rate change information in the frame “12” to the switching of the modulation scheme in the frame “0.” This can avoid a loss of information data due to a delay in supporting the QoS control.

On the other hand, assume that the modulation scheme is changed from a lower M-array modulation scheme, for example, QPSK or 16 QAM to a higher M-array modulation scheme such as 16 QAM or 64 QAM. In this event, the adaptive modulation controller 210 of the base station 200 notifies modulation scheme change instruction data to the terminal station 100 using the adaptive modulation control channel (MCHD) during a period of a frame “63” as shown in FIG. 5. Specifically, the modulation scheme is notified using the frame immediately before the modulation scheme switching timing (at the start of the frame “0”). Therefore, the terminal station 100 can switch the modulation scheme at the start of a frame next to the frame in which the change instruction data is received, in a manner similar to the first embodiment. In other words, the switching of the modulation scheme can be controlled without conducting a delay control.

Likewise, the adaptive modulation controller 210 of the base station 200 provides the transmission rate change information to its local QoS controller 211 during a period of the frame “63.” Then, at the start of the frame “0,” the adaptive modulation controller 210 sets switching to the modulation scheme for the modulator 202, and to the corresponding demodulation scheme for the demodulator 205.

As described above, according to the second embodiment, the QoS controllers 111, 211 are provided with the transmission rate change information at different timings when a higher M-array modulation scheme is changed to a lower M-array modulation scheme and when a lower M-array modulation scheme is changed to a higher M-array modulation scheme. This permits the QoS controllers 111, 211 to prepare for the QoS control making use of a sufficiently long period when the transmission rate is switched from a high rate to a low rate, thereby making it possible to avoid without fail a loss of information data due to a delay in supporting the QoS control.

In the respective embodiments described above, a modulation scheme is determined in accordance with one of the uplink channel and downlink channel which presents degraded propagation path characteristics. The present invention, however, is not limited to this particular manner of determining a modulation scheme. For example, when the transmission bands of the uplink channel and downlink channel are asymmetric, a modulation scheme may be determined by selecting the channel having a wider transmission band, and comparing the propagation path characteristics of the selected channel with a threshold. This strategy is based on a concept that more important communications should be made on a wider transmission band, and gives higher priority to the transmission efficiency such that the more important channel is prevented from being affected by the condition of the less important channel. In this event, since the state of the channel having a narrower transmission band is ignored, errors can be introduced during transmissions due to bad conditions on this channel. However, communications on this channel are inherently of less importance, and can be sufficiently recovered by such means as automatic re-transmission control. This strategy is particularly important, for example, when a server on a communication network such as the Internet is accessed from a terminal station to download an application program, a large capacity of data, and the like from this server.

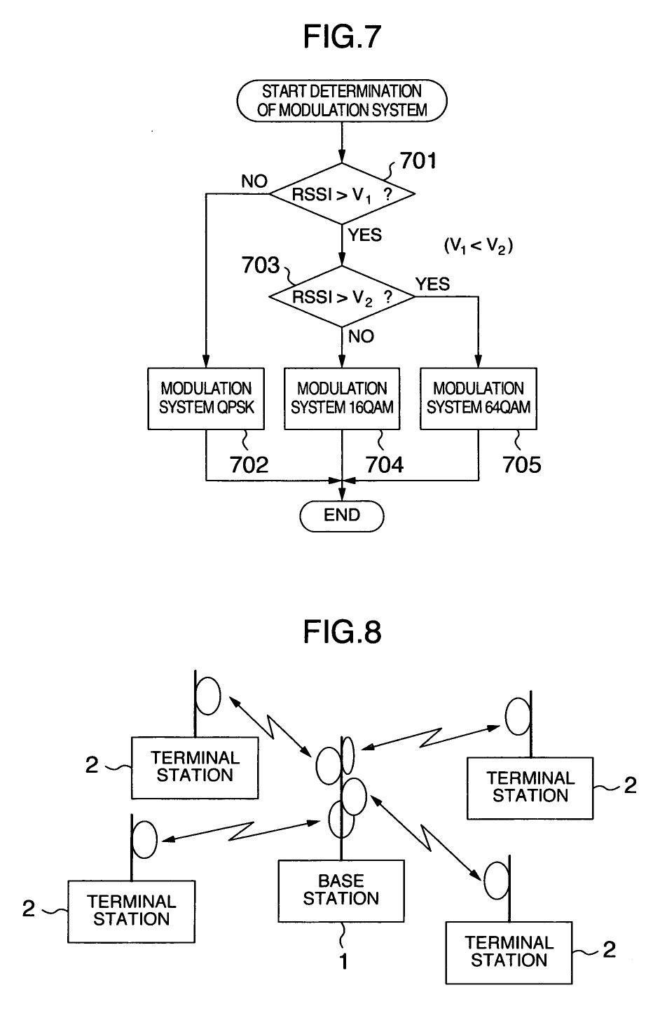

The foregoing example shows a method of determining a next modulation scheme in consideration of a current modulation scheme. However, a new modulation scheme can be determined directly from detected RSSI values for the uplink channel and downlink channel, without taking into consideration a current modulation scheme when determining a next modulation scheme. In doing so, a change can be smoothly made to a modulation scheme appropriate to a sudden degradation in the receiving condition, by way of example. FIG. 7 illustrates an exemplary flow chart for selecting a modulation scheme from three candidates, for example, QPSK, 16 QAM, and 64 QAM.

At step 701, the adaptive modulation controller 210 determines whether or not the lower one of an average RSSI value for the uplink channel and an average RSSI value for the downlink channel is less than a threshold V₁ , and selects QPSK as an appropriate modulation scheme in this situation when the average RSSI value exceeds the threshold V₁ (step 702). On the other hand, when the lower one of the average RSSI value for the uplink channel and the average RSSI value for the downlink channel is equal to or higher than the threshold V₁, the flow proceeds to step 703, where the adaptive modulation controller 210 determines whether or not the lower average RSSI value exceeds a threshold V₂(V₁<V₂). When the lower one of the average RSSI value for the uplink channel and the average RSSI value for the downlink channel exceeds the threshold V₂, the adaptive modulation controller 210 selects 64 QAM as an appropriate modulation scheme in this situation (step 705). On the other hand, when the lower average RSSI value is equal to or less than the threshold V₂, the adaptive modulation controller 210 selects 16 QAM as an appropriate modulation scheme in this situation.

In the foregoing example, when a current modulation scheme is changed to a next modulation scheme which provides a lower transmission rate, several modulation schemes may be gradually changed from one to another. For example, when a comparison of the current modulation scheme with the next modulation scheme reveals that there are a plurality of modulation schemes therebetween, modulation schemes with lower transmission rates may be changed from one to another to reach the final modulation scheme.

Further alternatively, a modulation scheme may be determined by calculating an average of an estimated value of the transmission path characteristics on the uplink channel and an estimated value of the transmission path characteristics on the downlink channel, and comparing the calculated average value with a threshold. In addition, when the average value is calculated, the estimated value of the transmission path characteristics on the uplink channel and the estimated value of the transmission path characteristics on the downlink channel may be multiplied by respective weighting coefficients which are determined in accordance with the importance of the uplink channel and downlink channel before the average value is calculated.

Further, while in the foregoing embodiments described above, the propagation path characteristics are estimated by detecting the RSSI of a received signal or calculating an equalization error, the propagation path characteristics may be estimated by detecting another value representative of the quality such as the ratio of signal to noise (Ec/No) or the like. Also, these values may be combined to estimate the propagation path characteristics.

Also, while each of the foregoing embodiments has been described in connection with an example in which the adaptive modulation controller is installed in the base station, the adaptive modulation controller may be installed in the terminal station.

The present invention can be applied to an FWA radio communication system as well, and FIG. 8 is a schematic diagram illustrating an exemplary configuration of such an FWA radio communication system to which the present invention is applied.

In this FWA radio communication system, there are a plurality of stationary terminal stations 2 installed in a radio communication service area of a stationary base station 1. Radio communications are made between the base station 1 and the terminal stations 2 to communicate data between user terminal devices (not shown) such as personal computers connected to the terminal stations 2, to communicate data with a backbone channel connected to the base station, and the like.

Each of the base station 1 and terminal stations 2 is a station device having a radio communication function, and parts associated with the radio communication function of the base station 1 and terminal station 2 have the same configuration to that illustrated in FIG. 1.

In the FWA radio communication system, data is communicated between the base station 1 and the terminal station 2, so that both the base station 1 and terminal station 2 have a radio which is configured to function as a transmitter or a receiver.

The present invention can also be applied to a subscriber wireless access system in which bidirectional communications are made between a plurality of terminal stations and a base station using an adaptive modulation scheme, and the terminal station has a function of notifying the base station of an estimated state on a first transmission path for transmitting information from the base station to the terminal station.

Otherwise, a variety of modifications can be made to the type of the system, the configuration of a first and a second communication apparatus, a procedure for adaptive modulation control in the first and second communication apparatuses and the contents of the procedure, and the type and number of modulation schemes, and the like in practicing the present invention without departing from the spirit and scope of the invention.

Essentially, the present invention is not limited to the exact embodiments described above, but can be embodied while modifying its components without departing from the spirit and scope of the invention in its implementation stage. Also, a variety of inventions can be formed by appropriate combinations of a plurality of components disclosed in the respective embodiments described above. For example, several components may be removed from all the components shown in each of the embodiments. Further, components across different embodiments may be combined as appropriate.

It should be further understood by those skilled in the art that although the foregoing description has been made on embodiments of the invention, the invention is not limited thereto and various changes and modifications may be made without departing from the spirit of the invention and the scope of the appended claims.

1. A radio communication method for making a bidirectional communication between a first communication apparatus and a second communication apparatus using an adaptive modulation scheme, said method comprising the steps of:
estimating a state on a first transmission path for transmitting information from said first communication apparatus to said second communication apparatus;
notifying the estimated state on the first transmission path from said second communication apparatus to said first communication apparatus;
estimating a state on a second communication path for transmitting information from said second communication apparatus to said first communication apparatus;
determining in said first communication apparatus a modulation scheme for use in the bidirectional communication based on the state on the first transmission path notified from said second communication apparatus and the estimated state on the second transmission path; and
making the bidirectional communication between said first communication apparatus and said second communication apparatus using the determined modulation scheme.

2. In a system for making a bidirectional communication between a first communication apparatus and a second communication apparatus using an adaptive modulation system, wherein said second communication apparatus has a function of estimating a state on a first transmission path for transmitting information from said first communication apparatus to said second communication apparatus and notifying said second communication apparatus of the estimated state, a radio communication apparatus for use as said first communication apparatus comprising:
means for receiving the state on the first transmission path notified from said second communication apparatus;
means for estimating a state on a second transmission path for transmitting information from said second communication apparatus to said first communication apparatus;
means for determining a modulation scheme for use in the bidirectional communication based on the state on the first transmission path notified from said second communication apparatus, and the estimated state on the second transmission path; and
means for making the bidirectional communication with said second communication apparatus using the determined modulation scheme.

3. A radio communication apparatus according to claim 2, wherein said means for determining a modulation scheme preferentially selects one of the state on the first transmission path and the state on the second transmission path which presents a lower quality when the first transmission path and the second transmission path have symmetry, and determines a modulation scheme in accordance with the state of the selected transmission path.

4. A radio communication apparatus according to claim 2, wherein said means for determining a modulation scheme makes a selection preferentially in consideration of one of the state on the first transmission path and the state on the second transmission path which has a wider transmission band, and determines a modulation scheme in accordance with the state of the selected transmission path.

5. A radio communication apparatus according to claim 2, wherein said means for determining a modulation scheme comprises:
means for determining a modulation scheme for use in the bidirectional communication based only on newly estimated states on the first and second transmission paths without considering a current modulation scheme.

6. A radio communication apparatus according to claim 2, wherein said means for determining a modulation scheme compares a current modulation scheme with a next modulation scheme when the current transmission system is changed to the next transmission system which provides a lower transmission rate, and upon detection of a plurality of communication systems therebetween, said means gradually changes one modulation scheme to another modulation scheme which provides a next lower transmission rate until a final modulation scheme is reached.

7. In a subscriber wireless access system for making a bidirectional communication between a plurality of terminal stations and a base station using an adaptive modulation system, wherein said terminal station has a function of estimating a state on a first transmission path for transmitting information from said base station to said terminal station and notifying said base station of the estimated state, said base station comprising:
means for receiving the state on the first transmission path notified from said terminal station;
means for estimating a state on a second transmission path for transmitting information from said terminal station to said base station;
means for determining a modulation scheme for use in the bidirectional communication based on the state on the first transmission path notified from said terminal station and the estimated state on the second transmission path; and
means for making the bidirectional communication with said terminal station using the determined modulation scheme.
